(19) United States
(12) Patent Application Publication
(10) Pub. No.: US 2026/0044399 A1
(43) Pub. Date: Feb. 12, 2026

(54) PROCESSOR WITH HEALTH-CHECK ENGINE

(71) Applicant: Nokia Solutions and Networks Oy, Espoo (FI)

(72) Inventor: Pranjal Kumar Dutta, Sunnyvale, CA (US)

(73) Assignee: Nokia Solutions and Networks Oy, Espoo (FI)

(21) Appl. No.: 18/799,553

(22) Filed: Aug. 9, 2024

(51) Int. Cl. G06F 11/07; G06F 9/38

(52) U.S. Cl. CPC G06F 11/0721; G06F 9/3867

(57) ABSTRACT

A processor, such as a CPU, has a health-check engine and one or more pipelined processor cores. The health-check engine triggers a core-level health-check operation by each processor core during which the processor core inserts a special health-check instruction (HCl) into its pipeline. If and when the HCl reaches the end of the pipeline, the processor core transmits a positive health-check response to the health-check engine. If the health-check engine receives a positive health-check response from each processor core before the expiration of a health-check timer, then the health-check engine determines that the CPU is operating properly; otherwise, not. In some embodiments, the CPU is part of an active component of a system having a standby component with its own CPU. When the active component detects a failure of its CPU, it informs the standby component to transition to an active role.

### BACKGROUND

### Field of the Disclosure

The present disclosure relates to computer processors and, more specifically but not exclusively, to microprocessors, such as central processing units (CPUs).

### Description of the Related Art

This section introduces aspects that may help facilitate a better understanding of the disclosure. Accordingly, the statements of this section are to be read in this light and are not to be understood as admissions about what is prior art or what is not prior art.

It is known to provision a system with two processors, where a first processor is configured to operate as an active processor while the second processor is configured as a standby processor that is available to operate as the active processor in case of failure of the first processor. For many applications, it is desirable for the transition of operations from a failed, active processor to a previous, standby processor to be completed relatively quickly to avoid lengthy interruption of those operations.

### SUMMARY

Problems in the prior art are addressed in accordance with the principles of the present disclosure by providing a processor with a health-check (HC) engine that quickly detects failure of the processor. For applications in which the processor functions as an active processor in a system having a second, standby processor, the quick failure detection enables processor operations to transition quickly from the failed processor to the second processor.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified block diagram of a routing system with built-in redundancy, according to certain embodiments of the disclosure;

FIG. 2 is a simplified block diagram representing the interaction between the active card controller and the active CPU of FIG. 1 associated with a CPU-level health-check operation;

FIG. 3 shows the general format of an x86 instruction containing various fields;

FIG. 4 is a flow diagram of the processing performed by the active card controller of FIGS. 1 and 2 to check the health of the active CPU;

FIG. 5 is a flow diagram of the processing performed by the HC engine of FIG. 2 to implement a CPU-level health check of the active CPU;

FIG. 6 is a flow diagram of the processing implemented by a processor core of FIG. 2 to process a core-level HCReq-P request;

FIG. 7 is a flow diagram of the processing implemented by a processor core of FIG. 2 to insert an HCl instruction in the core's pipeline as part of step 604 of FIG. 6; and

FIG. 8 is a flow diagram of the processing implemented by a processor core of FIG. 2 to generate a positive HCResp-P response.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

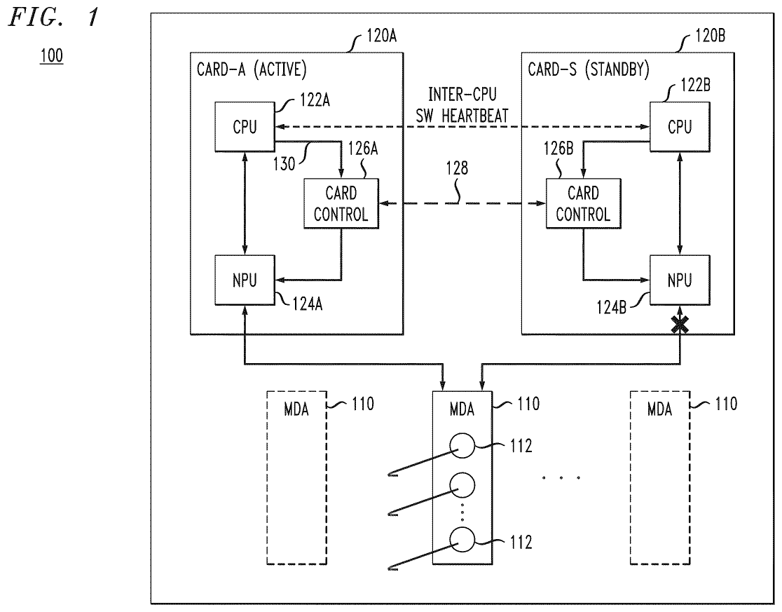

FIG. 1 is a simplified block diagram of a routing system 100 with built-in redundancy, according to certain embodiments of the disclosure. The routing system 100 has a set of one or more media-dependent adapter (MDA) cards 110 connected to a network (not shown in FIG. 1) and to a pair of control cards 120: an active control card 120A and a standby control card 120S, where (i) the active control card 120A supports the operations of the MDA cards 110 and (ii) the standby control card 120S is available to support those operations upon failure of the active control card 120A. An MDA card hosts a set of ports 112, including their transceivers for exchanging packets with the network and devices that implement the physical layer of the OSI (Open Systems Interconnections) model. For example, the transceivers could be small form-factor pluggables (SFPs) that are compact, hot-swappable, transceiver modules used for optical (and sometimes wired) communications on a port. A transceiver module could be connected to a chain of physical-layer devices on its north. The primary roles of the physical layer are encoding and decoding of data (packets) into code groups, coding schemes to improve signal integrity, modulation of signals, signal conditioning and synchronization, etc. The physical layer includes sublayers such as PCS (Physical Coding Sublayer), PMA (Physical Medium Attachment), and PMD (Physical Medium Dependent) that carry out these roles. A physical-layer device could be an ASIC (Application Specific Integrated Circuit) and typically known as the PHY.

Each control card 120 has a central processing unit (CPU) 122, a network processing unit (NPU) 124, and a card controller 126. The CPU 122 runs control software (e.g., the network operating system) for the control card 120 as well as system-specific components. The control software may include various control-plane protocols such as BGP, IS-IS, OSPF, LDP, RSVP-TE, etc. The NPU 124 is the packet-forwarding engine for the MDA cards 110. The NPU primarily implements the data-link layer and the network layer of the OSI model, whereas the MDA implements the physical layer. When the data-link layer is Ethernet, its MAC (Media Access Control) sublayer in the NPU 124 connects to a PHY device in the MDA card 110. The card controller 126, which may be implemented by one or more devices, such as (without limitation) field-programmable gate arrays (FPGAs), manages the hardware operations of the entire control card 120.

The routing system 100 may have any suitable number of MDA cards 110 with each MDA card 110 having any suitable number of ports 112. When a packet from the network arrives at a port 112, the MDA card 110 bicasts the packet to the two NPUs 124A and 124S of the active and standby control cards 120A and 120S, respectively. As part of the active control card 120A, the active NPU 124A is solely responsible for forwarding the network packet. As such, the standby control card 120S is configured to drop the packet, as indicated by the “X” in FIG. 1. When the NPU 124A recognizes that the network packet is a control protocol packet, the NPU 124A forwards the packet to the CPU 122A to be appropriately processed by the software running in the CPU 122A.

The card controller 126A plays a critical role in managing the redundancy between the active and standby control cards 120A and 120S. Software running in the active CPU 122A programs in the active card controller 126A that control card 120A needs to play the active role. The active and standby card controllers 126A and 126S communicate with each other through a hardware backplane 128 to negotiate the roles of the control cards 120. For example, in FIG. 1, control card 120A is in the active role, while control card 120S is in the standby role. Based on the negotiated roles, each card controller 126 indicates to its local NPU 124 about its role, based on which the NPU 124 decides to block or unblock packets sent to/received from the MDA cards 110.

The card controllers 126A and 126S repeatedly exchange active-standby status messages about the control cards 120, e.g., every few micro-seconds, through the hardware backplane 128 following a heartbeat protocol. If and when a failure of the active CPU 122A is detected, the active card controller 126A will transmit a status message via the hardware backplane 128 to the standby card controller 126S indicating that the standby control card 120S needs to transition to the active role.

According to certain embodiments of the disclosure, the active card controller 126A periodically transmits a health-check (HC) request (HCReq) to the active CPU ACA via path 130. In response to the receipt of an HCReq, the active CPU 122A performs a CPU-level HC operation to determine whether the CPU 122A is functioning properly. If so, then the CPU 122A transmits a positive HC response (HCResp) back to the card controller 126A, in which case, the active card controller 126A maintains the previous status messages to the standby card controller 126S indicating that the control card 120S should remain in the standby role. Otherwise, if the CPU 122A detects a failure in the operations of the CPU 122A, then the CPU 122A fails to transmit a positive HCResp back to the card controller 126A within a specified duration after the HCReq has been transmitted to the CPU 122A, in which case, the active card controller 126A changes the status messages sent to the standby card controller 126S to instruct the standby control card 120S to transition to the active role.

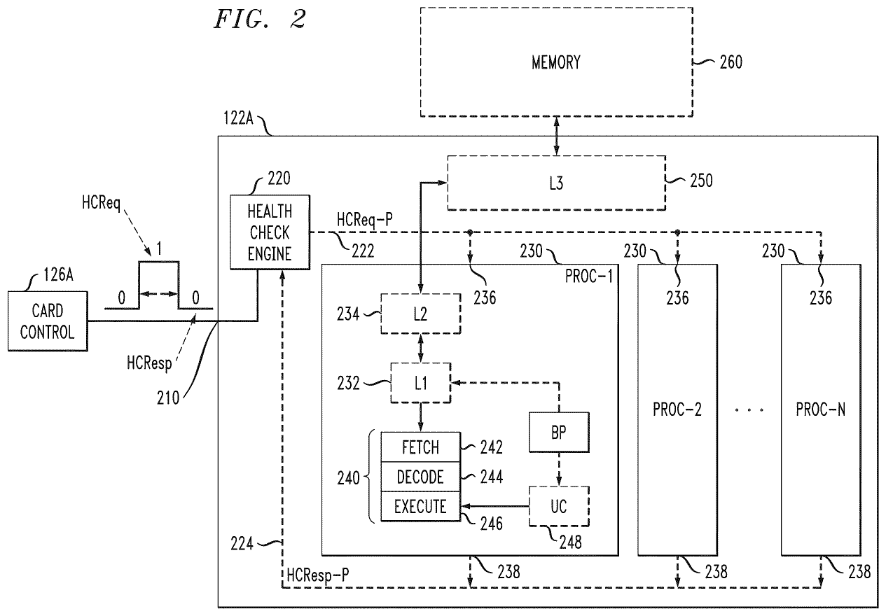

FIG. 2 is a simplified block diagram representing the interaction between the active card controller 126A and the active CPU 122A of FIG. 1 associated with a CPU-level health-check operation. As shown in FIG. 2, CPU 122A has a health-monitor pin 210 connected to an internal health-check engine 220 that is also connected to one or more pipelined, CPU processor cores 230, each of which has an execution pipeline 240 of pipeline stages, represented generically by abstract stages labeled fetch 242, decode 244, and execute 246, where a fetch stage 242 retrieves a CPU instruction from memory (e.g., either L1 cache 232, L2 cache 234, L3 cache 250, or external RAM/ROM memory 260), a decode stage 244 decodes a retrieved instruction, and an execute stage 246 executes a decoded instruction. Those skilled in the art will understand that, in general, a CPU processor core pipeline 240 may have any suitable number of stages that process instructions in a pipelined manner, wherein the different pipeline stages sequentially process a set of instructions in parallel with each instruction at a different stage of the processing.

As represented in FIG. 2, to request the CPU-level health-check operation, the card controller 126A drives the health-monitor pin 210 of the CPU 122A high (i.e., logic 1) as an HCReq request, which, in turn, causes the HC engine 220 to initiate a CPU-level HC operation, as described below.

If the HC engine 220 determines that the CPU 122A is functioning properly, then the HC engine 220 drives the health-monitor pin 210 low (i.e., logic 0) as an HCResp response within a specified duration programmed into the card controller 126A. In that case, the card controller 126A maintains the status of control card 120A as active and the status of control card 120S as standby. If, however, the HC engine 220 determines that the CPU 122A is not functioning properly (or if the HC engine 220 otherwise fails to make a determination), then the HC engine 220 will not drive the health-monitor pin 210 low. In that case, after the expiration of the specified duration without detecting the health-monitor pin 210 being driven low, the card controller 126A will determine that the status of control card 120A needs to transition to inactive and the status of control card 120S needs to transition to the active role.

In some implementations, the card controller 126A can periodically trigger CPU-level HC operations by the CPU 122A, for example, at sub-millisecond intervals such as every 500 us-800 us.

Note that, in alternative implementations, instead of a single health-monitor pin 210, the CPU 122A could have two pins: one to receive HCReq requests and the other to transmit HCResp responses.

To initiate a CPU-level HC operation upon receipt of a HCReq from the card controller 126A, the HC engine 220 transmits a core-level HC request (HCReq-P) to each CPU processor core 230. In response, each CPU processor core 230 performs a core-level HC operation (as described below) and, when operating properly, generates and transmits to the HC engine 220, within a specified duration programmed into the HC engine 220 (shorter than the specified duration programmed into the card controller 126A), a positive core-level HC response (HCResp-P). If a CPU processor core 230 is not operating properly, then it will not transmit a positive HCResp-P response to the HC engine 220.

If the HC engine 220 receives a positive HCResp-P from each and every processor core 230 within the specified duration, then the HC engine 220 determines that the CPU 122A is functioning properly and will drive the health-monitor pin 210 low. If, however, the HC engine 220 fails to receive a positive HCResp-P from at least one processor core 230 within the specified duration, then the HC engine 220 determines that the CPU 122A is not functioning properly and will not drive the health-monitor pin 210 low.

FIG. 2 generically represents the assertion of the core-level HCReq-P requests from the HC engine 220 to on-core interconnects 236 of the different CPU processor cores 230 and the assertion of the core-level HCResp-P responses from on-core interconnects 238 of the different CPU processor cores 230 to the HC engine 220 using dashed lines 222 and 224, respectively. Those skilled in the art will understand that, depending upon the particular implementation, each of line 222 and line 224 may independently represent (i) a shared bus between the HC engine 220 and the multiple processor cores 230 or (ii) multiple, discrete signal paths between the HC engine 220 and the individual processor cores 230 or (iii) a combination of both. In addition, depending on the particular implementation, the HCReq-P requests may be transmitted sequentially or in parallel, and the HCResp-P responses may be transmitted sequentially or in parallel.

To perform a core-level HC operation, upon receipt of an HCReq-P, a CPU processor core 230 inserts a special health-check instruction (HCl) into its execution pipeline 240. When the HCl is finally executed/seen by the last stage of the pipeline 240, the core 230 sends a positive HCResp-P to the HC engine 220. As shown in FIG. 2 and as described above, a pipeline 240 may include fetch, decode, and execute stages.

### Fetch Stage

In a fetch stage 242, the processor core 230 fetches a block of instructions from the L1 cache. A cache is a smaller and faster memory located within a processor core 230 (or shared between processor cores) that stores blocks of memory (instructions or data) frequently fetched from memory. Fetching from memory takes 20-30 processor cycles, and thus caches reduce the number of cycles if the required instructions or data are found in the cache (i.e., hit in the cache). Typically, there is a hierarchy of caches between memory and a processor core 230. The L1 cache 232 is located on a processor core 230 and is the smallest and the fastest cache (e.g., 2-3 processor cycles). Next in the hierarchy is the larger and slower L2 cache 234, also located on the processor core 230. Further next in the hierarchy is the L3 cache 250, which is larger and slower than the L2 cache. The L3 cache is shared among the processor cores 230. Instructions or data are fetched from memory 260 only if those are missing in all the three caches. A block of instructions or data stored in a cache is called a “cache line”. Typical size of a cache line is 64B.

### Decode Stage

The format and encoding of instructions of a processor core 230 are defined by the Instruction Set Architecture (ISA) implemented by the processor. Well-known ISAs are x86, MIPS, ARM, etc. ISAs like x86 have variable-length instructions. After an instruction block is fetched from the L1 cache 232, the length of the instructions needs to be decoded to find the instruction's boundaries within the block. A processor core 230 may employ one or more Instruction-Length Decoders (ILD) to extract the instructions from the block.

The instructions supplied from a block may contain one or more conditional branch instructions. A conditional branch instruction may alter the instruction sequence based on outcome of the condition associated with the conditional branch instruction. The outcome is not known until the conditional branch instruction is executed, but the processor core 230 cannot stall the pipeline 240 until the conditional branch instruction is executed. This problem is solved by a Branch Prediction (BP) unit, which predicts the outcome of a conditional branch instruction and accordingly fetches the desired instruction sequence followed by the conditional branch instruction.

A processor core 230 cannot execute the ISA instructions due to the complexities associated with ISA instructions. The processor core 230 translates each ISA instruction to one or more fixed-sized micro-operations (UOPs), specific to the micro-architecture of the processor. The processor core 230 finally executes in units of its native UOPs. A decode stage 244 employs one or more instruction decoders (IDs) that decode the incoming stream of ISA instructions into equivalent UOPs. Instruction decoding is very costly and may take several processor cycles. A processor core 230 employs a micro-op cache (UC) 248 to store the decoded instructions. UC 248 can also be termed as the L0 cache. By default, an instruction (rather, its UOPs) is always fetched from UC 248. If an instruction is missing in UC 248, then its associated block of instructions is fetched from L1 cache, decoded, and stored in UC 248.

### Execute Stage

An execute stage 246 executes the UOPs supplied by the previous stage of the pipeline 240. This is the final stage that completes execution of an instruction.

### Core-level Health Check

When a core-level HCReq-P request is received by a processor core 230, the core's pipeline 240 may already be processing instructions for a program. The HCReq-P triggers injection of an HCl instruction into the pipeline 240 amidst the instructions of the program. HCl is not associated with the executing program and neither is it fetched from memory. A special memory address is assigned to HCl, such as, for example, all bits in the address as 1 (e.g., 0xffffffffffffffff in a 64-bit processor). This special address is termed the HCl address. The HCl address does not point to a real memory location of the executing program, but rather indicates the HCl itself. The IP (instruction pointer) is a register in the processor core 230 (not shown in FIG. 2) that keeps track of the next instruction to be fetched in the program. Unless a branch instruction changes the execution sequence, the IP is always incremented to fetch the subsequent instruction in the execution sequence. To inject the HCl, the IP is temporarily changed to the HCl address, which triggers injection of HCl into the pipeline 240. After HCl is injected, the IP is changed back to the next instruction of the program. Since an execute stage 246 accepts only UOPs, the UOP(s) decoded from the HCl are injected to the execute stage 246. If the UOP for HCl is not found in UC 248, then HCl is dynamically decoded through a decode stage 244, like any other instruction. When the HCl is executed by the final execute stage 246 of the pipeline 240, the processor core 230 sends a positive HCResp-P response to the HC engine 220. If the HCl fails to reach the pipeline's final execute stage 246 or if the HCl reaches the final execute stage 246 too late, then no positive HCResp-P will be sent to the HC engine 220 within the specified duration.

Since only one HCl needs to be processed by a processor core 230, processing the HCl employs a very minimal number of cycles of the executing program. Hence, the technique is highly scalable and allows the card controller 126A to trigger CPU-level health-check operations at very high frequency (e.g., every 500 us-800 us).

### Implementation of HCl

This section describes the implementation of HCl for the x86 Instruction Set Architecture. Those skilled in the art will understand how to implement HCl for other ISAs. Before describing the implementation of HCl in x86, it is important to understand the encoding of an x86 instruction.

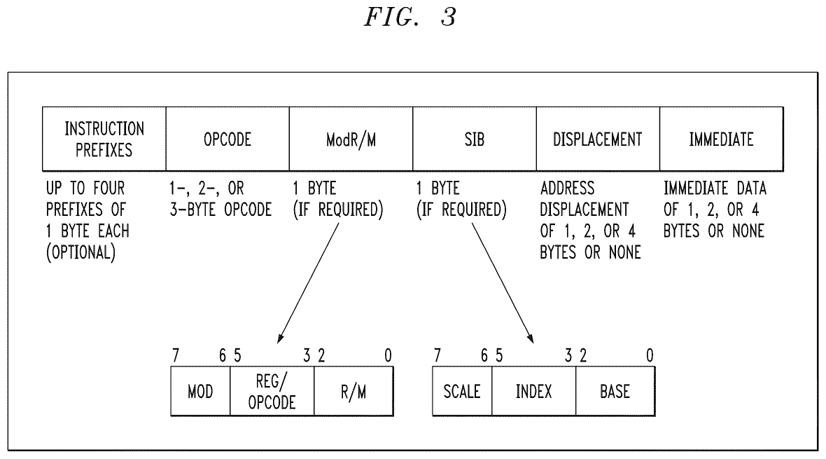

FIG. 3 shows the general format of an x86 instruction containing various fields.

The Opcode field is a single byte denoting the basic operation of the instruction. Thus, this field is mandatory and allows up to 256 primary Opcode maps. For example, 0x74 is the Opcode for a conditional short jump to a location with a relative offset of 0x7f in program memory. Alternative Opcode maps are defined using escape sequences which require 2-3 bytes in the Opcode field. For example, an escape sequence is a 2-byte Opcode encoded as [0f<opcode>]. Here, 0f identifies the alternative Opcode map. For example, 0f 84 is the opcode for a conditional jump to a location that is too far away for a short jump to reach.

The semantics of the 1-byte, optional ModR/M field are Mode-Register-Memory. If the instruction has at least one operand (i.e., based on the Opcode), then the ModR/M field specifies the operand(s) and their addressing mode. The bits in this field are divided into the following sub-fields:
Mod: Bits 6-7 describe four different addressing modes for transferring data between memory and a register EAX.
Reg: Bits 3-5 specify source or destination register. This allows encoding of the eight general-purpose registers in x86 architecture.
R/M: Bits 0-2, combined with Mod field, specify either (i) the only operand in a single-operand instruction like NOT or NEG or (ii) the second operand in a two-operand instruction.

The 1-byte, optional SIB field, whose semantics are Scale-Index-Base, is used for scaled indexed addressing mode (specified in Mod).

Displacement, a variable-length field of 1, 2, or 4 bytes, has multiple use cases. In some use cases, Displacement contains a non-zero offset value. In control instructions, Displacement contains the address of a control block in program memory as either an absolute value (e.g., added to the base of program memory address) or a relative value (e.g., offset from the address of the control instruction).

Immediate is a variable-length field that contains a constant operand of an instruction.

Instruction Prefixes is an optional, variable-length field that can contain up to four prefixes where each prefix is a 1-byte field. This field changes the default operation of x86 instructions. For example, 66h is “Operand Override” prefix, which changes the size of data expected by the default mode of instruction, such as 64-bit to 16-bit etc. Currently, x86 ISA supports following prefixes:
Prefix group 1
   a. 0xF0: LOCK prefix
   b. 0xF2: REPNE/REPNZ prefix
   c. 0xF3: REP or REPE/REPZ prefix
Prefix group 2
   a. 0x2E: CS segment override
   b. 0x36: SS segment override
   c. 0x3E: DS segment override
   d. 0x26: ES segment override
   e. 0x64: FS segment override
   f. 0x65: GS segment override
   g. 0x2E: Branch not taken
   h. 0x3E: Branch taken
Prefix group 3
   a. 0x66: Operand-size override prefix
Prefix group 4
   a. 0x67: Address-size override prefix

Currently, there is no unallocated one-byte Opcode in x86. So, certain embodiments of this disclosure define an HCl with a two-byte Opcode. The first byte in the two-byte Opcode is 0x0f, which indicates the instruction having a two-byte Opcode. The second byte uniquely identifies the instruction. Currently, second-byte values from 0x18-0x1f are defined as HINT_NOP instructions. A HINT_NOP instruction contains only a two-byte operand field. When the execute stage 246 of a pipeline 240 sees a HINT_NOP instruction, it does nothing and simply moves to the next instruction. The format of one HINT_NOP instruction is [0xf 0x18]. A HINT_NOP instruction can be reused as the HCl instruction when the address of the instruction is a special address bearing all bits as 1. This is just one example of a unique definition of HCl in x86. In general, an ISA (x86 and the like) can define an HCl in its own suitable way.

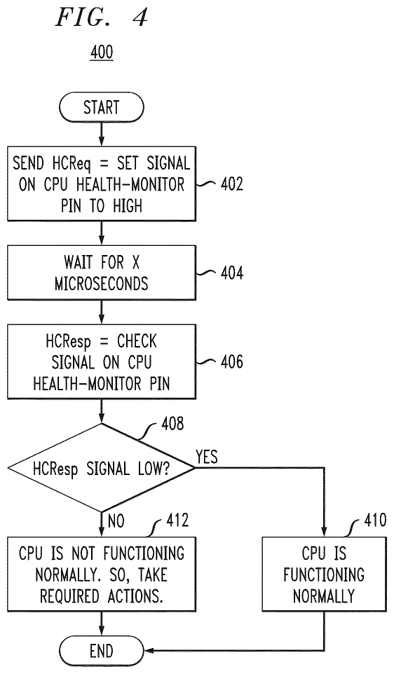

FIG. 4 is a flow diagram of the processing 400 performed by the card controller 126A of FIGS. 1 and 2 to check the health of the CPU 122A. The processing 400 may be executed by the card controller 126A periodically, likely with a very high frequency such as every 500 us-800 us.

In step 402, the card controller 126A asserts an HCReq request on the CPU's health-monitor pin 210. In FIG. 2, HCReq is implemented by setting the signal level on the pin 210 to high. In step 404, the card controller 126A waits for X microseconds to allow the maximum time to receive an HCResp response on the pin 210. The value of X may be provided by the specification of the CPU 122A. For example, if the health-check interval is every 500 us, then X may be 100 us.

In step 406, the card controller 126A reads the signal level on the health-monitor pin 210. In step 408, the card controller 126A determines if the signal level on the pin indicates a positive HCResp. In FIG. 2, HCResp is implemented by the CPU 122A setting the signal level of the health-monitor pin 210 to low. If the pin's signal level indicates a positive HCResp, then the processing 400 proceeds to step 410, where the card controller 126A determines that the CPU 122A is functioning normally, and therefore no changes to the statuses of the control cards 120A and 120S need to be made. Otherwise, in step 408, the card controller 126A determines that the pin's signal level does not indicate a positive HCResp within the specified duration. In that case, in step 412, the card controller 126A determines that the CPU 122A is not functioning normally, and the statuses of the control cards 120A and 120S need to be changed, as described previously.

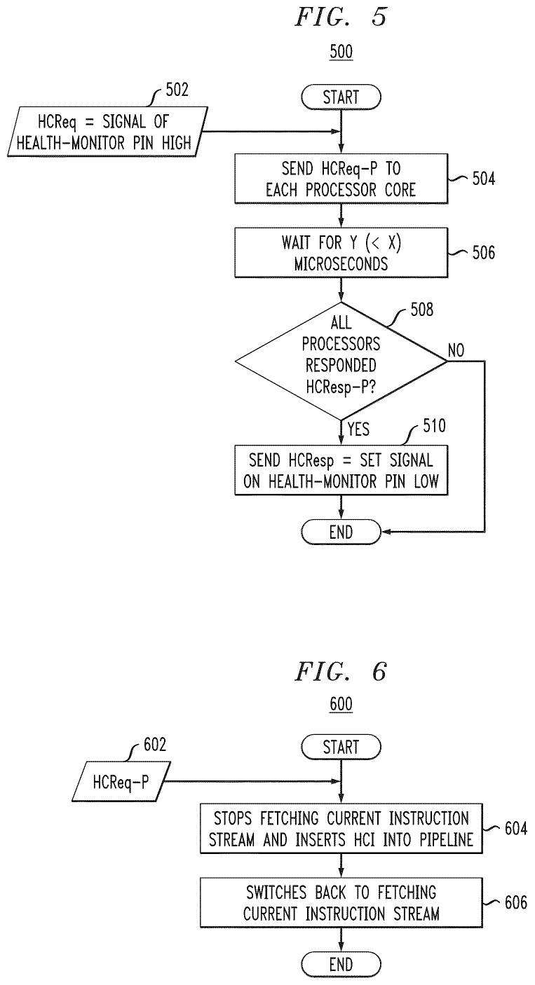

FIG. 5 is a flow diagram of the processing 500 performed by the HC engine 220 of FIG. 2 to implement a CPU-level health check of the CPU 122A. In step 502, the HC engine 220 receives an HCReq request on the health-monitor pin 210. In step 504, the HC engine 220 sends a core-level HCReq-P request to each processor core 230. In step 506, the HC engine 220 waits for Y microseconds before checking for HCResp-P responses from each processor core 230. The value of Y, which must be less than X of FIG. 4, may be chosen based on maximum response time of a processor core 230. For example, if X is 100 us, then Y may be 50 us.

In step 508, the HC engine 220 determines if all of the processor cores 230 have responded with a positive HCResp-P response. If so, then, in step 510, the HC engine 220 asserts a positive HCResp response by driving the health-monitor pin 210 low. Otherwise, at least one processor core 230 failed to respond with a positive HCResp-P within the specified duration, in which case, the processing 500 of FIG. 5 terminates without the HC engine 220 changing the status of the signal level at the health-monitor pin 210.

FIG. 6 is a flow diagram of the processing 600 implemented by a processor core 230 of FIG. 2 to process a core-level HCReq-P request. In step 602, the processor core 230 receives an HCReq-P. In step 604, the processor core 230 stops fetching the next instruction in the current instruction stream (of the currently executing program or interrupt handler) and inserts a HCl instruction into the pipeline 240. In step 606, the processor core 230 switches back to fetching the next instruction in the current instruction stream.

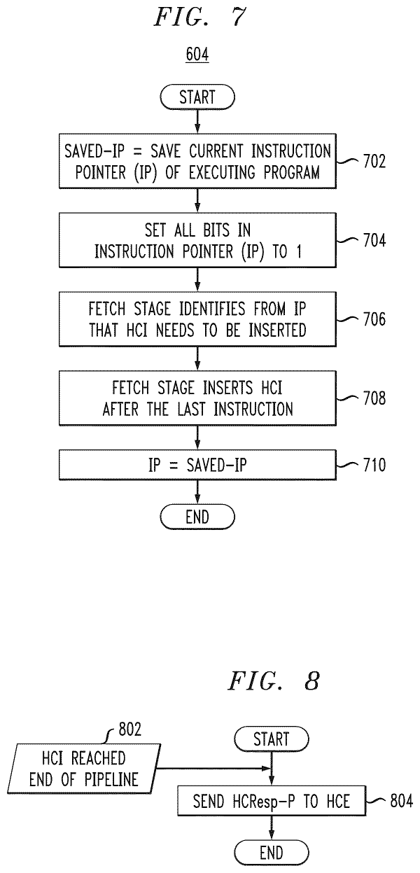

FIG. 7 is a flow diagram of the processing implemented by a processor core 230 of FIG. 2 to insert an HCl instruction in the pipeline 240 as part of step 604 of FIG. 6. In step 702, the processor core 230 saves the value in an instruction pointer (IP) register (which points to the next instruction of the currently executing program) to an alternative register, termed as “Saved-IP”. In step 704, the processor core 230 sets the IP register to the special address that indicates the address of HCl. For example, the special address could be all bits in the address set to 1.

In step 706, a fetch stage 242 of the pipeline 240 looks at the IP register to find the address of the next instruction to be fetched. However, the fetch stage 242 finds that the IP register indicates HCl. In step 708, the fetch stage 242 inserts the HCl into the next stage in the pipeline 240 by associating the HCl with its special address. In step 710, the processor core 230 restores the value in Saved-IP into the IP register, so that the processor core continues fetching the next instruction of the program.

FIG. 8 is a flow diagram of the processing implemented by a processor core 230 of FIG. 2. to generate a positive HCResp-P response. In step 802, the HCl instruction reaches the end of the pipeline 240. In step 804, the processor core 230 sends the positive HCResp-P response to the HC engine 220.

Although the present disclosure has been described in the context of the redundant routing system 100 of FIGS. 1 and 2 having active and standby control cards 120A and 120S with CPUs 122A and 122S and card controllers 126A and 126S, where the card controller 126A triggers CPU-level HC operations by CPU 122A, those skilled in the art will understand that the present disclosure is not so limited. In general, the disclosure is related to a CPU or any other suitable processor having an internal health-check engine that is configured to perform processor-level HC operations by triggering core-level HC operations by the processor's one or more pipelined cores. Those processor-level HC operations may be (i) triggered by an external agent, such as, but not limited to, a card controller (as in FIGS. 1 and 2) or (ii) triggered internally. The processor may (i) report the results to an external agent (and in FIGS. 1 and 2) or (ii) simply shut down operations upon detection of a failure. The processor might be part of a redundant system having a standby processor (as in FIGS. 1 and 2) or it might be part of a suitable, non-redundant architecture that does not have a standby process.

In certain embodiments, the present disclosure is an apparatus comprising a processor, the processor comprising a health-check (HC) engine and at least one pipelined processor core comprising a pipeline of pipeline stages from a first pipeline stage to a last pipeline stage. The HC engine is configured to (i) assert an HC request to the processor core and (ii) start an HC timer. In response to receiving the HC request, when operating properly, the processor core is configured to insert an HC instruction into the first pipeline stage; progress the HC instruction through the pipeline from the first pipeline stage to the last pipeline stage; and in response to the HC instruction reaching the last pipeline stage, assert a positive HC response to the HC engine. The HC engine is configured to interpret (i) receipt of the positive HC response before expiration of the HC timer as an indication that the processor core is operating properly and (ii) expiration of the HC timer without receiving the positive HC response as an indication that the processor core is not operating properly.

In at least some of the above embodiments, the processor is a central processing unit (CPU).

In at least some of the above embodiments, the CPU is configured to execute x86 instructions.

In at least some of the above embodiments, the processor further comprises one or more health-monitor pins connected to the HC engine and configurable to receive a processor-level HC request from an external agent and, in response, provide a processor-level HC response to the external agent.

In at least some of the above embodiments, one health-monitor pin is configurable to receive the processor-level HC request from the external agent at a first logic level and, in response, provide the processor-level HC response to the external agent at a second, different logic level.

In at least some of the above embodiments, the HC instruction has an address that does not point to a real memory location.

In at least some of the above embodiments, the processor is configurable as a first processor of a system further comprising a second processor; the first processor is configurable to operate as an active processor of the system in which the second processor operates as a standby processor; and, upon the first processor determining that the processor core is not operating properly, the second processor is configured to become the active processor for the system.

In at least some of the above embodiments, the apparatus comprises the first and second processors.

In at least some of the above embodiments, the first processor is configurable as part of a first control card further comprising a first card controller; the second processor is part of a second control card further comprising a second card controller; and, upon the first processor determining that the processor core is not operating properly, the first card controller is configured to instruct the second card controller to cause the second processor to become the active processor for the system.

In at least some of the above embodiments, the apparatus comprises the first and second control cards.

In at least some of the above embodiments, the apparatus, further comprises one or more health-monitor pins configurable to receive a processor-level HC request from the first card controller and, in response, provide a processor-level HC response to the first card controller.

In at least some of the above embodiments, the processor comprises a plurality of pipelined processor cores operating in parallel; and the HC engine is configured to interpret (i) receipt of positive HC responses from all of the processor cores before expiration of the HC timer as the indication that the processor core is operating properly and (ii) expiration of the HC timer without receiving a positive HC response from at least one processor core as the indication that the processor core is not operating properly.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,”as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system”or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. Apparatus comprising a processor, the processor comprising:
a health-check (HC) engine; and
at least one pipelined processor core comprising a pipeline of pipeline stages from a first pipeline stage to a last pipeline stage, wherein:
the HC engine is configured to (i) assert an HC request to the processor core and (ii) start an HC timer;
in response to receiving the HC request, when operating properly, the processor core is configured to:
insert an HC instruction into the first pipeline stage;
progress the HC instruction through the pipeline from the first pipeline stage to the last pipeline stage; and
in response to the HC instruction reaching the last pipeline stage, assert a positive HC response to the HC engine; and
the HC engine is configured to interpret (i) receipt of the positive HC response before expiration of the HC timer as an indication that the processor core is operating properly and (ii) expiration of the HC timer without receiving the positive HC response as an indication that the processor core is not operating properly.

2. The apparatus of claim 1, wherein the processor is a central processing unit (CPU).

3. The apparatus of claim 2, wherein the CPU is configured to execute x86 instructions.

4. The apparatus of claim 1, wherein the processor further comprises one or more health-monitor pins connected to the HC engine and configurable to receive a processor-level HC request from an external agent and, in response, provide a processor-level HC response to the external agent.

5. The apparatus of claim 4, wherein one health-monitor pin is configurable to receive the processor-level HC request from the external agent at a first logic level and, in response, provide the processor-level HC response to the external agent at a second, different logic level.

6. The apparatus of claim 1, wherein the HC instruction has an address that does not point to a real memory location.

7. The apparatus of claim 1, wherein:
the processor is configurable as a first processor of a system further comprising a second processor;
the first processor is configurable to operate as an active processor of the system in which the second processor operates as a standby processor; and
upon the first processor determining that the processor core is not operating properly, the second processor is configured to become the active processor for the system.

8. The apparatus of claim 7, wherein the apparatus comprises the first and second processors.

9. The apparatus of claim 7, wherein:
the first processor is configurable as part of a first control card further comprising a first card controller;
the second processor is part of a second control card further comprising a second card controller; and
upon the first processor determining that the processor core is not operating properly, the first card controller is configured to instruct the second card controller to cause the second processor to become the active processor for the system.

10. The apparatus of claim 9, wherein the apparatus comprises the first and second control cards.

11. The apparatus of claim 9, further comprising one or more health-monitor pins configurable to receive a processor-level HC request from the first card controller and, in response, provide a processor-level HC response to the first card controller.

12. The apparatus of claim 1, wherein:
the processor comprises a plurality of pipelined processor cores operating in parallel; and
the HC engine is configured to interpret (i) receipt of positive HC responses from all of the processor cores before expiration of the HC timer as the indication that the processor core is operating properly and (ii) expiration of the HC timer without receiving a positive HC response from at least one processor core as the indication that the processor core is not operating properly.

13. A method for performing a health-check (HC) operation in a processor comprising an HC engine and at least one pipelined processor core comprising a pipeline of pipeline stages from a first pipeline stage to a last pipeline stage, the method comprising:
the HC engine (i) asserting an HC request to the processor core and (ii) starting an HC timer;
in response to receiving the HC request, when operating properly, the processor core:
inserts an HC instruction into the first pipeline stage;
progresses the HC instruction through the pipeline from the first pipeline stage to the last pipeline stage; and
in response to the HC instruction reaching the last pipeline stage, asserts a positive HC response to the HC engine; and
the HC engine interprets (i) receipt of the positive HC response before expiration of the HC timer as an indication that the processor core is operating properly and (ii) expiration of the HC timer without receiving the positive HC response as an indication that the processor core is not operating properly.

14. The method of claim 13, wherein the processor further comprises one or more health-monitor pins connected to the HC engine and that receive a processor-level HC request from an external agent and, in response, provide a processor-level HC response to the external agent.

15. The method of claim 14, wherein one health-monitor pin receives the processor-level HC request from the external agent at a first logic level and, in response, provides the processor-level HC response to the external agent at a second, different logic level.

16. The method of claim 13, wherein:
the processor is configured as a first processor of a system further comprising a second processor;
the first processor operates as an active processor of the system in which the second processor operates as a standby processor; and
upon the first processor determining that the processor core is not operating properly, the second processor becomes the active processor for the system.

17. The method of claim 16, wherein:
the first processor is configured as part of a first control card further comprising a first card controller;
the second processor is part of a second control card further comprising a second card controller; and
upon the first processor determining that the processor core is not operating properly, the first card controller instructs the second card controller to cause the second processor to become the active processor for the system.

18. The method of claim 17, wherein the processor further comprises one or more health-monitor pins configured to receive a processor-level HC request from the first card controller and, in response, provide a processor-level HC response to the first card controller.

19. The method of claim 13, wherein:
the processor comprises a plurality of pipelined processor cores operating in parallel; and
the HC engine interprets (i) receipt of positive HC responses from all of the processor cores before expiration of the HC timer as the indication that the processor core is operating properly and (ii) expiration of the HC timer without receiving a positive HC response from at least one processor core as the indication that the processor core is not operating properly.
